(19) United States
(12) Patent Application Publication
(10) Pub. No.: US 2026/0251073 A1
(43) Pub. Date: Aug. 27, 2026

(54) ACTIVE TIP CLEARANCE CONTROL SYSTEM FOR AIRCRAFT ENGINE

(71) Applicant: PRATT & WHITNEY CANADA CORP., Longueuil (CA)

(72) Inventors: Xiaoliu LIU, Longueuil (CA); Jerzy MAKUSZEWSKI, Mississauga (CA)

(21) Appl. No.: 19/064,090

(22) Filed: Feb. 26, 2025

(51) Int. Cl. F01D 11/24

(52) U.S. Cl. CPC F01D 11/24; F05D 2220/323; F05D 2260/201; F05D 2260/606

(57) ABSTRACT

An aircraft engine includes a gas path annularly extending around a central axis in serial flow communication across a compressor and turbine. The turbine has a casing, a shroud secured to the casing, and blades radially inward of the shroud, with a clearance defined between blade tips and the shroud. An active tip clearance control device for directing a flow of cooling air to the casing includes a first cooling air source at a first temperature, a second cooling air source at a second temperature than the first temperature, and a valve having a first inlet fluidly connected to the first air source, a second inlet fluidly connected to the second air source, and an outlet selectively connectible to the first and second inlets. The outlet is fluidly connected to the casing to selectively direct the flow of air from the first or second air source to the casing.

### TECHNICAL FIELD

The disclosure relates generally to aircraft engines, and, more particularly, to active clearance control systems in aircraft engines.

### BACKGROUND

Aircraft engines can be provided with active tip clearance control (ATCC) systems that are designed to vary the radial gap between the turbine blades and surrounding shroud in order to optimize tip clearance. Active tip clearance control systems typically use cooler engine air to selectively cool the turbine casing to modulate the tip clearance. However, improvements are sought.

### SUMMARY

In one aspect, there is provided an aircraft engine, comprising: a gas path annularly extending around a central axis and extending in serial flow communication across a compressor and a turbine, the turbine having a casing and a shroud secured to and located radially inwardly of the casing, a set of blades disposed radially inward of the shroud in the turbine, a clearance defined between tips of the set of blades and the shroud; and an active tip clearance control device for directing a flow of cooling air to the casing, the active tip clearance control device including: a first cooling air source at a first temperature; a second cooling air source at a second temperature, the second temperature greater than the first temperature; and a valve having a first inlet fluidly connected to the first cooling air source, a second inlet fluidly connected to the second cooling air source, and an outlet selectively connectible to the first inlet and to the second inlet, the outlet fluidly connected to the casing to selectively direct the flow of cooling air from the first cooling air source or the second cooling air source to the casing.

In certain embodiments, the aircraft engine as defined above includes one or more of the following features, in whole or in part, and in any combination.

In an embodiment, the turbine is a high pressure turbine and the aircraft engine further includes a low pressure turbine downstream of the high pressure turbine along the gas path, the low pressure turbine including a low pressure shroud surrounding low pressure blades, the aircraft engine further including a conduit fluidly connecting the casing to the low pressure shroud.

In an embodiment, the aircraft engine further includes an additional conduit fluidly connecting the low pressure shroud to the gas path inside the low pressure turbine.

In an embodiment, the turbine further includes a manifold radially outward of the casing, the manifold in fluid communication with the outlet of the valve to direct the flow of cooling air to the casing.

In an embodiment, the manifold includes a baffle radially outward of the casing and impingement holes disposed through the baffle for impinging the flow of cooling air against the casing.

In an embodiment, the aircraft engine further includes a controller adapted to direct the valve to open to the first cooling air source upon receipt of an indication of the aircraft engine operating in a first engine operating condition, the controller further adapted to direct the valve to open to the second cooling air source upon receipt of an indication of the aircraft engine operating in a second engine operating condition.

In an embodiment, the controller is configured to direct the valve to open to the first cooling air source upon receipt of an indication of the aircraft engine operating in a cruise condition and to direct the valve to open to the second cooling air source upon receipt of an indication of the aircraft engine operating in a take-off condition or a descent condition.

In an embodiment, the first cooling air source is a first bleed location in the compressor and the second cooling air source is a second bleed location in the compressor downstream of the first bleed location.

In another aspect, there is provided a system for controlling a clearance between tips of turbine blades and a turbine casing in an aircraft engine, comprising: a first cooling air source operating at a first temperature; a second cooling air source operating at a second temperature greater than the first temperature; a conduit fluidly coupling the first cooling air source and the second cooling air source to the turbine casing; a valve in the conduit, the valve having a first inlet fluidly connected to the first cooling air source, a second inlet fluidly connected to the second cooling air source, and an outlet selectively connectible to the first inlet and to the second inlet, the outlet fluidly connected to the turbine casing to selectively direct a flow of cooling air from the first cooling air source or the second cooling air source to the turbine casing; and a controller configured to direct the valve to open to the first cooling air source upon receipt of an indication of the aircraft engine operating in a first engine operating condition, the controller further configured to direct the valve to open to the second cooling air source upon receipt of an indication of the aircraft engine operating in a second engine operating condition.

In certain embodiments, the system as defined above includes one or more of the following features, in whole or in part, and in any combination.

In an embodiment, the turbine casing is a high pressure turbine casing, the system further comprising an additional conduit fluidly coupling the high pressure turbine casing to a shroud of a low pressure turbine downstream of the high pressure turbine.

In an embodiment, the additional fluid conduit further extends between the shroud of the low pressure turbine and an engine gas path at the low pressure turbine.

In an embodiment, the controller is configured to direct the valve to open to the first cooling air source upon receipt of an indication of the aircraft engine operating in a cruise condition and to direct the valve to open to the second cooling air source upon receipt of an indication of the aircraft engine operating in a take-off condition or a descent condition.

In an embodiment, the conduit includes a manifold radially outward of the turbine casing and fluidly coupling to the outlet of the valve to the turbine casing.

In an embodiment, the manifold includes a baffle radially outward of the turbine casing and impingement holes disposed through the baffle for impinging air from the conduit against the turbine casing.

In an embodiment, the first cooling air source is a first bleed location in a compressor of the aircraft engine and the second cooling air source is a second bleed location in the compressor downstream of the first bleed location.

In a further aspect, there is provided a method for controlling a clearance between turbine blades and a turbine casing in an aircraft engine, comprising: when the aircraft engine is operating in a first engine operating condition, flowing a first flow of cooling air operating at a first temperature to the turbine casing; and when the aircraft engine is operating at a second engine operating condition, activating a valve to block the first flow of cooling air and to flow a second flow of cooling air operating at a second temperature, the second temperature greater than the first temperature, to the turbine casing.

In certain embodiments, the method as defined above includes one or more of the following features, in whole or in part, and in any combination.

In an embodiment, the method further includes, when the aircraft engine is operating in the first engine operating condition, flowing the first flow of cooling air from the turbine casing to a shroud of a low pressure turbine; and when the aircraft engine is operating in the second engine operating condition, flowing the second flow of cooling air from the turbine casing to the shroud of the low pressure turbine.

In an embodiment, the method further includes flowing the first flow of cooling air or the second flow of cooling air from the shroud of the low pressure turbine into the a gas path of the aircraft engine at the low pressure turbine.

In an embodiment, the method further includes receiving, at a controller of the aircraft engine, an indication that the aircraft engine is operating in the first engine operating condition or in the second engine operating condition; and transmitting, from the controller to the valve, a signal to open the valve to the first flow of cooling air or to the second flow of cooling air based on the indication.

In an embodiment, when the aircraft engine is operating in the first engine operating condition, the flowing the first flow of cooling air comprises bleeding the first flow of cooling air from a first bleed location in a compressor of the aircraft engine; and when the aircraft engine is operating in the second engine operating condition, the flowing the second flow of cooling air comprises bleeding the second flow of cooling air from a second bleed location in the compressor downstream of the first bleed location.

### BRIEF DESCRIPTION OF THE DRAWINGS

Reference is now made to the accompanying figures in which:

FIG. 1 is a schematic cross sectional view of a gas turbine engine;

FIG. 2 is a block diagram of an active tip clearance control device for the engine of FIG. 1;

FIG. 3 is a schematic cross sectional view of a turbine section for the engine of FIG. 1 with the active tip clearance control device of FIG. 2;

FIG. 4 is a flow chart of an exemplary method for operating the active tip clearance control device of FIG. 2; and FIG. 5 is a block diagram of an example computing system for implementing the method of FIG. 4.

### DETAILED DESCRIPTION

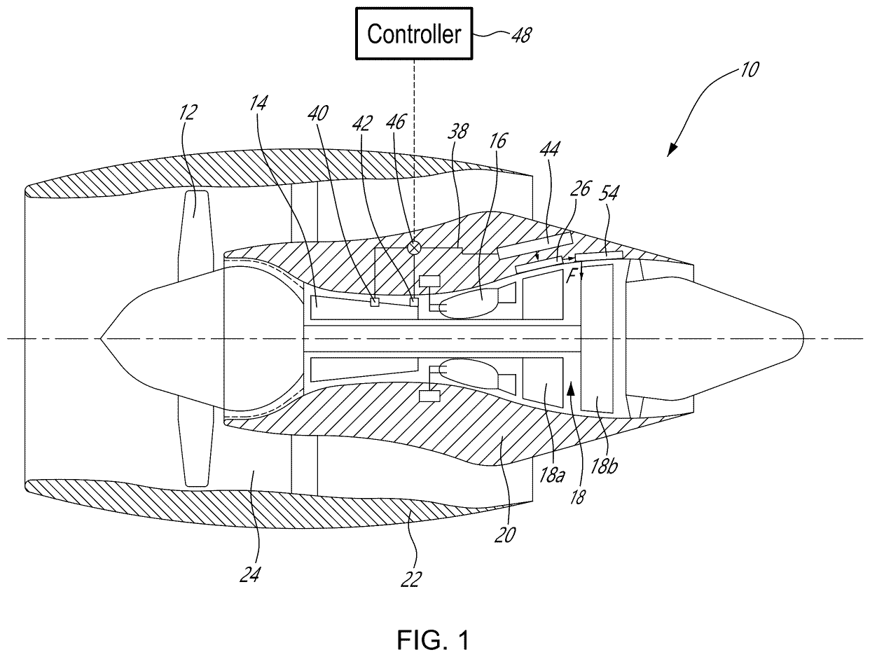

FIG. 1 illustrates a gas turbine engine 10 of a type preferably provided for use in subsonic flight, generally comprising in serial flow communication a fan 12 through which ambient air is propelled, a compressor section 14 for pressurizing the air, a combustor 16 in which the compressed air is mixed with fuel and ignited for generating an annular stream of hot combustion gases, and a turbine section 18 for extracting energy from the combustion gases. A core casing 20 surrounds the compressor section 14, combustor 16, and turbine section 18. A housing or nacelle 22 surrounds the core casing 20 and defines an annular bypass passage 24 therebetween. While FIG. 1 depicts engine 10 as a turbofan engine, it is understood that other aircraft engine types are contemplated.

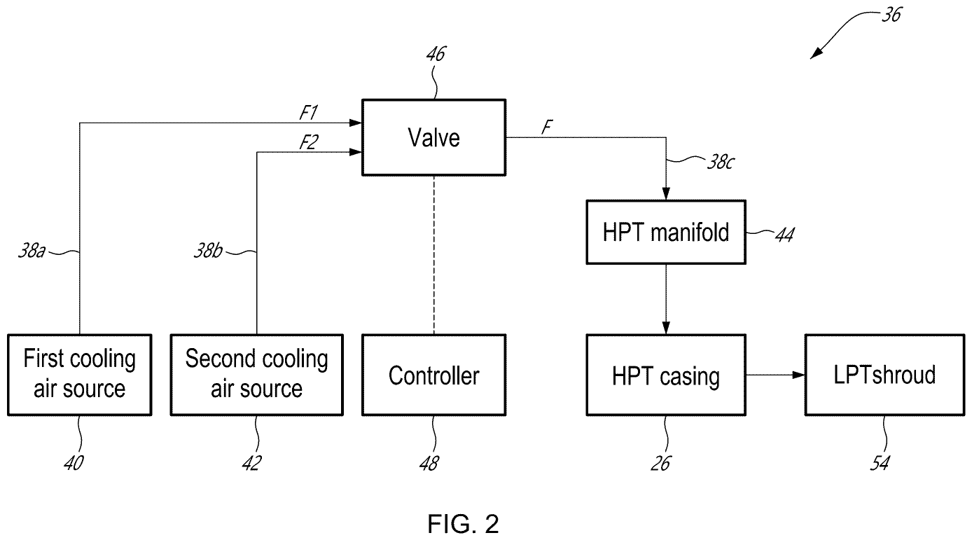

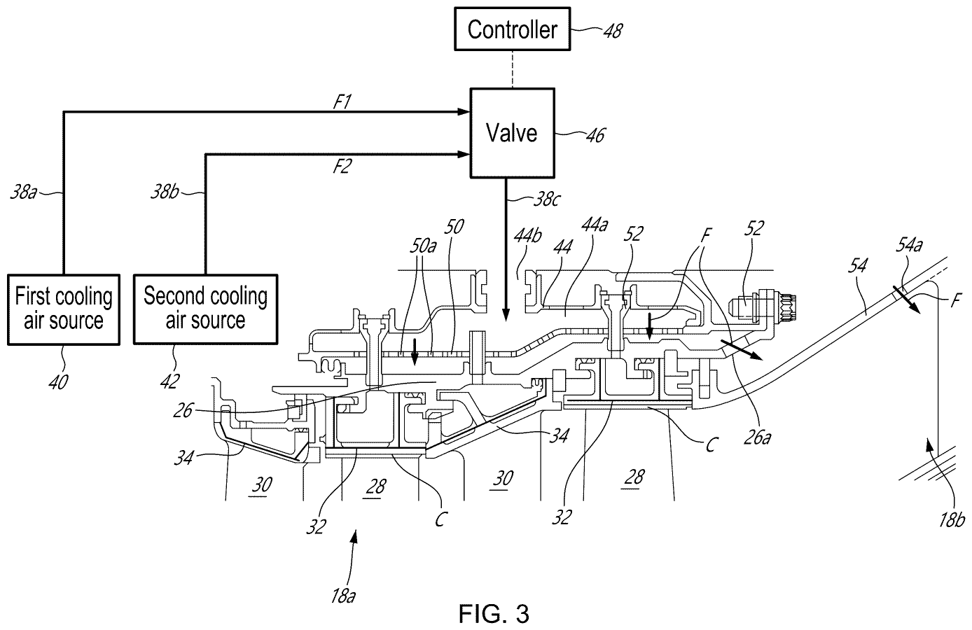

Referring additionally to FIGS. 2 and 3, the turbine section 18 includes a high pressure turbine 18a downstream of the combustor 16 and a low pressure turbine 18b downstream of the high pressure turbine 18a. In other cases, engine 10 can include only a single turbine section 18. Illustratively, the high pressure turbine 18a includes a casing 26, also referred to as a housing, that surrounds rotating blades 28 and stationary vanes 30. In embodiments, different numbers of blades 28 and vanes 30 are contemplated. As noted above, the blades 28 are adapted to extract work from the gas flow, while the vanes 30 are adapted to direct the gas flow, for instance to a subsequent set of rotating blades 28. Other high pressure turbine 18a configurations are contemplated. In the shown case, the high pressure turbine 18a includes a shroud 32 secured to and located radially inwardly of the casing 26. The vanes 30 are secured to the casing 26 via one or more vane platforms 34. The blades 28 are adapted to rotate within the shroud 32, with a tip clearance C defined between the radially outer ends (or tips) of the blades 28 and the radially inner surface of the shroud 32.

Maintaining an appropriate tip clearance C can help in preventing performance losses, for instance due to leakage between the tip of a blade 28 and the shroud 32. However, the tip clearance C is known to vary under different engine operating conditions, for instance throughout different stages of a flight. In addition, the blades 28 typically expand radially due to thermal growth during engine operation, thereby affecting the tip clearance. It is thus desirable to maintain an appropriate tip clearance C, for instance by cooling (and thereby shrinking) the casing 26 to which the shroud 32 is mounted to reduce the clearance C.

In accordance with the present disclosure, there is provided an active tip clearance control (ATCC) device 36, also referred to as an active clearance control (ACC) device, for varying the clearance C between the tips of the blades 28 and the radially inner surface of the shroud 32. In particular, the device 36 is adapted for selectively providing a flow F of cooling air to the casing 26 to vary a size thereof, thereby varying the clearance C between the tips of the blades 28 and the shroud 32 supported by the casing 26. Stated differently, the temperature-induced contraction of the casing 26 forces the shroud 32 to approach the tips of the blades 28 to reduce the clearance C. As such, the device 36 is also referred to as a system for controlling a clearance between tips of turbine blades 28 and the radially inner surface of the shroud 32. The degree of contraction of the casing 26 may be controlled by varying the temperature and pressure of the flow F of air, as discussed in further detail below.

The depicted device 36 includes a conduit 38a, 38b, 38c for flowing cooling air from one of a first cooling air source 40 or a second cooling air source 42 to the casing 26. In the shown case, a manifold 44 is annularly disposed about the casing 26 for fluidly coupling the conduit 38a, 38b, 38c to the casing 26. The device 36 further includes a valve 46, also referred to as a two-way valve or a switching valve, in the conduit 38a, 38b, 38c for selectively fluidly coupling and uncoupling the first cooling air source 40 and the second cooling air source 42 from the casing 26. Stated differently, the valve 46 is adapted to switch the source of cooling air (i.e., a first flow F1 from the first cooling air source 40 or a second flow F2 from the second cooling air source 42) flowing towards the casing 26. As such, the conduit 38a, 38b, 38c illustratively includes a first conduit portion 38a fluidly coupling the first cooling air source 40 to a first inlet of the valve 46, a second conduit portion 38b fluidly coupling the second cooling air source 42 to a second inlet of the valve 46, and a third conduit portion 38c fluidly coupling an outlet of the valve 46 to the casing 26 (illustratively via the manifold 44). A controller 48 is illustratively provided for controlling the positioning of the valve 46. For instance, the controller 48 can receive an indication of an engine operating mode (e.g., cruise, takeoff or descent) and control the valve 46 to switch from the first cooling air source 40 to the second cooling air source 42 (or vice-versa). Various valve 46 types are contemplated.

As shown in FIG. 1, the first cooling air source 40 and the second cooling air source 42 are bleed locations in the compressor 14. Other locations within the engine 10 are contemplated. The second cooling air source 42 is illustratively located downstream of the first cooling air source 40 in the compressor 14. As such, the second cooling air source 42 provides cooling air at a greater temperature and a greater pressure than the cooling air provided by the first cooling air source 40. In an exemplary embodiment, the first cooling air source 40 is located at a position within the compressor 14 to provide P2.8 air, while the second cooling air source 42 is located at a position within the compressor 14 to provide P3 air. Other locations within the compressor 14 are contemplated, for instance the first cooling air source 40 providing P2.1 air and the second cooling air source 42 providing P2.5 air. By varying the temperature and pressure of the air F flowing to the casing 26, the degree of contraction of the casing 26 is controlled. Stated differently, the cooling air from the first cooling air source 40, being at a lower temperature and pressure than the cooling air from the second cooling air source 42, will effect a greater degree of contraction of the casing 26, thereby reducing the tip clearance C.

As noted above, the valve 46 is controlled to flow cooling air F from the first cooling air source 40 or from the second cooling air source 42 to the casing 26 based on an operating condition of the engine 10. For instance, during a cruising condition of the aircraft, it is desirable to provide colder air from the first cooling air source 40 to the casing 26 to minimize the tip clearance C, thereby improving performance and efficiency of the engine 10. In other conditions, for instance at a takeoff or landing condition of the aircraft, it is desirable to provide a greater tip clearance C. As such, air from the second cooling air source 42 at a higher temperature than the air from the first cooling air source 40 is flowed to the casing to increase the tip clearance C. Other operating modes conditions for the engine 10, and the corresponding air provided to the casing 26 at such conditions, are contemplated.

Referring to FIG. 3, one embodiment of the manifold 44 is shown. Illustratively, the manifold 44 includes an annular cavity 44a surrounding the casing 26 and an inlet 44b fluidly coupling the valve 46 to the annular cavity 44a via the third conduit portion 38c. A baffle 50 extends substantially axially through the annular cavity 44a around the casing 26, with exemplary fasteners 52 securing the manifold 44 and baffle 50 to the casing 26. Other attachments are contemplated. In some cases, the baffle 50 is integrated with the manifold 44. A plurality of impingement holes 50a through the baffle 50 are provided for impinging the cooling air flow F against the radially outer surface of the casing 26. The number, sizing and arrangement of the impingement holes 50a can vary. In other cases, the baffle 50 is omitted.

Referring to FIGS. 1-3, as discussed above, the depicted engine 10 includes a low pressure turbine 18b downstream of the high pressure turbine 18a relative to the core gas flow. It is thus advantageous to direct the flow F of cooling gas from the casing 26 of the high pressure turbine 18a to components of the low pressure turbine 18b to provide additional cooling thereto. In particular, in the shown case, after impinging on the casing 26, the cooling air F is directed through an aperture 26a in the casing 26 towards a shroud 54 of the low pressure turbine 18b, thereby cooling the shroud 54. The depicted shroud includes one or more apertures 54a through which the flow F of cooling air is passes to enter the core gas flow in the low pressure turbine 18b, for instance to provide additional air to the low pressure turbine blades (not shown). Advantageously, by flowing the cooling air F into the core gas flow at the low pressure turbine 18b after the cooling occurs, additional work can be extracted from the air F to create thrust. Other configurations are contemplated, for instance directing the cooling flow F into core gas flow downstream of the casing 26, or into the bypass passage 24 downstream of the casing 26 and/or the low pressure turbine shroud 54.

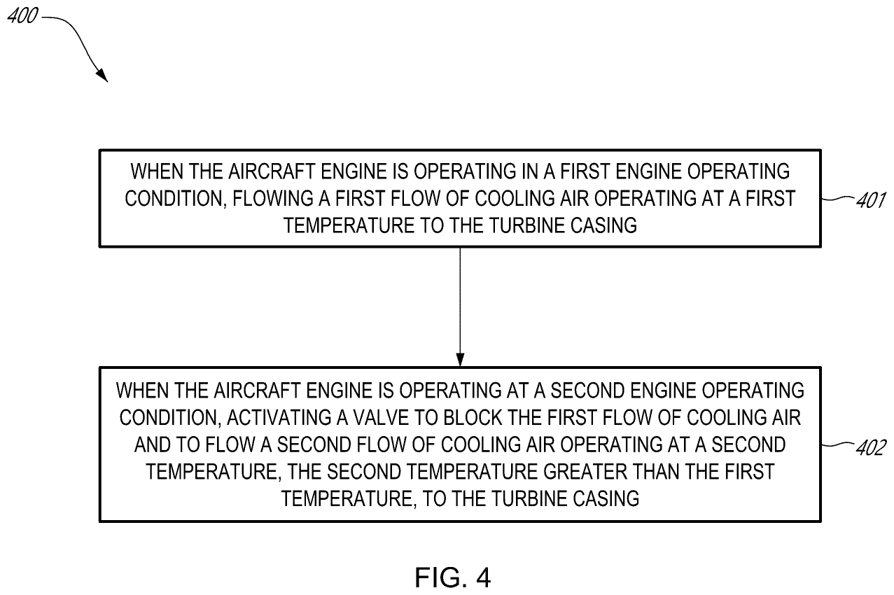

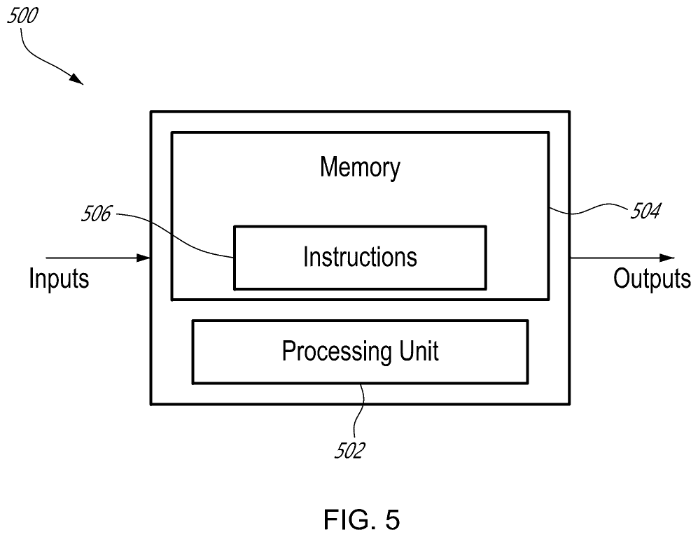

Referring now to FIG. 4, there is shown an exemplary method 400 for controlling a clearance C between turbine blades 28 and a turbine casing 26 (in particular, the shroud 32 of the casing 26) in an aircraft engine 10. At step 401, when the aircraft engine 10 is operating in a first engine operating condition (for instance, in a cruising condition), a first flow F1 of cooling air operating at a first temperature is flowed to the turbine casing 26. At step 402, when the aircraft engine 10 is operating at a second engine operating condition, a valve 46 is activated to block the first flow F1 of cooling air and to flow a second flow F2 of cooling air operating at a second temperature, the second temperature greater than the first temperature, to the turbine casing 26. Various modifications and additions to the above method 400 are contemplated.

With reference to FIG. 5, in some embodiments, the method 400 may be implemented using a computing device 500 (for instance that includes controller(s) 48) comprising a processing unit 502 and a memory 504 which has stored therein computer-executable instructions 506. The processing unit 502 may comprise any suitable devices configured to implement the method 400 such that instructions 506, when executed by the computing device 500 or other programmable apparatus, may cause the functions/acts/steps of the method 400 as described herein to be executed. The processing unit 502 may comprise, for example, any type of general-purpose microprocessor or microcontroller, a digital signal processing (DSP) processor, a central processing unit (CPU), an integrated circuit, a field programmable gate array (FPGA), a reconfigurable processor, other suitably programmed or programmable logic circuits, other suitable processing systems or circuits, or any combination thereof.

The memory 504 may comprise any suitable known or other machine-readable storage medium. The memory 504 may comprise non-transitory computer readable storage medium, for example, but not limited to, an electronic, magnetic, optical, electromagnetic, infrared, or semiconductor system, apparatus, or device, or any suitable combination of the foregoing. The memory 504 may include a suitable combination of any type of computer memory that is located either internally or externally to the device, for example random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like. Memory 504 may comprise any storage means (e.g., devices) suitable for retrievably storing machine-readable instructions 506 executable by processing unit 502. In some embodiments, the computing device 500 can be implemented as part of a full-authority digital engine controls (FADEC) or other similar devices, including electronic engine control (EEC), engine control unit (ECU), and the like.

The methods and systems described herein may be implemented in a high level procedural or object oriented programming or scripting language, or a combination thereof, to communicate with or assist in the operation of a computer system, for example the computing device 500. Alternatively, the methods and systems may be implemented in assembly or machine language. The language may be a compiled or interpreted language. Program code for implementing the methods and systems for detection may be stored on a storage media or a device, for example a ROM, a magnetic disk, an optical disc, a flash drive, or any other suitable storage media or device. The program code may be readable by a general or special-purpose programmable computer for configuring and operating the computer when the storage media or device is read by the computer to perform the procedures described herein. Embodiments of the methods and systems may also be considered to be implemented by way of a non-transitory computer-readable storage medium having a computer program stored thereon. The computer program may comprise computer-readable instructions which cause a computer, or in some embodiments the processing unit 502 of the computing device 500, to operate in a specific and predefined manner to perform the functions described herein.

Computer-executable instructions may be in many forms, including program modules, executed by one or more computers or other devices. Generally, program modules include routines, programs, objects, components, data structures, etc., that perform particular tasks or implement particular abstract data types. Typically the functionality of the program modules may be combined or distributed as desired in various embodiments.

According to the present disclosure, there is provided an aircraft engine system for varying the tip clearance between rotating turbine blades and the surrounding casing, based on the engine operating mode, by selecting between sources of cooling air being at different temperatures. Advantageously, the temperature and pressure of the cooling air provided to the turbine is selected based on the desired level of shrinkage of the casing, which has a direct effect on the tip clearance. As such, fuel and air consumption are improved due to the minimization of tip clearance losses. In addition, in embodiments where the cooling air flow, after being used to cool the low and high pressure turbine casings or shrouds, is directed into the core gas flow path at the low pressure turbine, additional work or thrust is generated.

It is noted that various connections are set forth between elements in the preceding description and in the drawings. It is noted that these connections are general and, unless specified otherwise, may be direct or indirect and that this specification is not intended to be limiting in this respect. A coupling between two or more entities may refer to a direct connection or an indirect connection. An indirect connection may incorporate one or more intervening entities. The term “connected” or “coupled to” may therefore include both direct coupling (in which two elements that are coupled to each other contact each other) and indirect coupling (in which at least one additional element is located between the two elements).

It is further noted that various method or process steps for embodiments of the present disclosure are described in the preceding description and drawings. The description may present the method and/or process steps as a particular sequence. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the description should not be construed as a limitation.

Furthermore, no element, component, or method step in the present disclosure is intended to be dedicated to the public regardless of whether the element, component, or method step is explicitly recited in the claims. As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

While various aspects of the present disclosure have been disclosed, it will be apparent to those of ordinary skill in the art that many more embodiments and implementations are possible within the scope of the present disclosure. For example, the present disclosure as described herein includes several aspects and embodiments that include particular features. Although these particular features may be described individually, it is within the scope of the present disclosure that some or all of these features may be combined with any one of the aspects and remain within the scope of the present disclosure. References to “various embodiments,” “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. The use of the indefinite article “a” as used herein with reference to a particular element is intended to encompass “one or more” such elements, and similarly the use of the definite article “the” in reference to a particular element is not intended to exclude the possibility that multiple of such elements may be present.

The embodiments described in this document provide non-limiting examples of possible implementations of the present technology. Upon review of the present disclosure, a person of ordinary skill in the art will recognize that changes may be made to the embodiments described herein without departing from the scope of the present technology. Yet further modifications could be implemented by a person of ordinary skill in the art in view of the present disclosure, which modifications would be within the scope of the present technology.

1. An aircraft engine, comprising:
a gas path annularly extending around a central axis and extending in serial flow communication across a compressor and a turbine, the turbine having a casing and a shroud secured to and located radially inwardly of the casing, a cavity surrounding the casing, a set of blades disposed radially inward of the shroud in the turbine, a clearance defined between tips of the set of blades and the shroud; and
an active tip clearance control device for directing a flow of cooling air to the casing, the active tip clearance control device including:
a first cooling air source at a first temperature;
a second cooling air source at a second temperature, the second temperature greater than the first temperature; and
a valve having a first inlet fluidly connected to the first cooling air source, a second inlet fluidly connected to the second cooling air source, and an outlet selectively connectible to the first inlet and to the second inlet, the outlet fluidly connected to the casing such that the valve is configured to selectively direct the flow of cooling air from the first cooling air source or the second cooling air source to the casing;
wherein the turbine is a high pressure turbine and the aircraft engine further includes a low pressure turbine downstream of the high pressure turbine along the gas path, the low pressure turbine including a low pressure shroud surrounding low pressure blades, the aircraft engine further including a conduit fluidly connecting the casing to the low pressure shroud, a first aperture through the casing fluidly coupling the cavity to an additional cavity surrounding the low pressure shroud, a second aperture through the low pressure shroud fluidly coupling the addition cavity to the gas path inside the low pressure turbine.

2-3. (canceled)

4. The aircraft engine as defined in claim 1, wherein the turbine further includes a manifold radially outward of the casing, the manifold in fluid communication with the outlet of the valve to direct the flow of cooling air to the casing.

5. The aircraft engine as defined in claim 4, wherein the manifold includes a baffle radially outward of the casing and impingement holes disposed through the baffle for impinging the flow of cooling air against the casing.

6. The aircraft engine as defined in claim 1, further comprising a controller adapted to direct the valve to open to the first cooling air source upon receipt of an indication of the aircraft engine operating in a first engine operating condition, the controller further adapted to direct the valve to open to the second cooling air source upon receipt of an indication of the aircraft engine operating in a second engine operating condition.

7. The aircraft engine as defined in claim 6, wherein the controller is configured to direct the valve to open to the first cooling air source upon receipt of an indication of the aircraft engine operating in a cruise condition and to direct the valve to open to the second cooling air source upon receipt of an indication of the aircraft engine operating in a take-off condition or a descent condition.

8. The aircraft engine as defined in claim 1, wherein the first cooling air source is a first bleed location in the compressor and the second cooling air source is a second bleed location in the compressor downstream of the first bleed location.

9. A system for controlling a clearance between tips of turbine blades and a turbine casing in an aircraft engine, comprising:
a first cooling air source operating at a first temperature;
a second cooling air source operating at a second temperature greater than the first temperature;
a conduit fluidly coupling the first cooling air source and the second cooling air source to the turbine casing;
a valve in the conduit, the valve having a first inlet fluidly connected to the first cooling air source, a second inlet fluidly connected to the second cooling air source, and an outlet selectively connectible to the first inlet and to the second inlet, the outlet fluidly connected to the turbine casing such that the valve is configured to selectively direct a flow of cooling air from the first cooling air source or the second cooling air source to the turbine casing; and
a controller configured to direct the valve to open to the first cooling air source upon receipt of an indication of the aircraft engine operating in a first engine operating condition, the controller further configured to direct the valve to open to the second cooling air source upon receipt of an indication of the aircraft engine operating in a second engine operating condition;
wherein the turbine casing is a high pressure turbine casing, the system further comprising an additional conduit fluidly coupling the high pressure turbine casing to a shroud of a low pressure turbine downstream of the high pressure turbine, a first aperture through the high pressure turbine casing fluidly coupling a cavity surrounding the high pressure turbine casing to an additional cavity surrounding the low pressure shroud, a second aperture through the low pressure shroud fluidly coupling the additional cavity to an engine gas path at the low pressure turbine.

10-11. (canceled)

12. The system as defined in claim 9, wherein the controller is configured to direct the valve to open to the first cooling air source upon receipt of an indication of the aircraft engine operating in a cruise condition and to direct the valve to open to the second cooling air source upon receipt of an indication of the aircraft engine operating in a take-off condition or a descent condition.

13. The system as defined in claim 9, wherein the conduit includes a manifold radially outward of the turbine casing and fluidly coupling to the outlet of the valve to the turbine casing.

14. The system as defined in claim 13, wherein the manifold includes a baffle radially outward of the turbine casing and impingement holes disposed through the baffle for impinging air from the conduit against the turbine casing.

15. The system as defined in claim 9, wherein the first cooling air source is a first bleed location in a compressor of the aircraft engine and the second cooling air source is a second bleed location in the compressor downstream of the first bleed location.

16. A method for controlling a clearance between turbine blades and a turbine casing in an aircraft engine, comprising:
when the aircraft engine is operating in a first engine operating condition, flowing a first flow of cooling air operating at a first temperature to the turbine casing, and flowing the first flow of cooling air from the turbine casing to a shroud of a low pressure turbine via a first aperture through the turbine casing fluidly coupling a cavity surrounding the high pressure turbine casing to an additional cavity surrounding the shroud of the low pressure, and via a second aperture through the shroud of the low pressure turbine fluidly coupling the additional cavity to an engine gas path at the low pressure turbine; and
when the aircraft engine is operating at a second engine operating condition, activating a valve to block the first flow of cooling air and to flow a second flow of cooling air operating at a second temperature, the second temperature greater than the first temperature, to the turbine casing, and flowing the second flow of cooling air from the turbine casing to the shroud of the low pressure turbine.

17-18. (canceled)

18. The method as defined in claim 16, further comprising flowing the first flow of cooling air or the second flow of cooling air from the shroud of the low pressure turbine into the a gas path of the aircraft engine at the low pressure turbine.

19. The method as defined in claim 16, further comprising:
receiving, at a controller of the aircraft engine, an indication that the aircraft engine is operating in the first engine operating condition or in the second engine operating condition; and
transmitting, from the controller to the valve, a signal to open the valve to the first flow of cooling air or to the second flow of cooling air based on the indication.

20. The method as defined in claim 16, wherein:
when the aircraft engine is operating in the first engine operating condition, the flowing the first flow of cooling air comprises bleeding the first flow of cooling air from a first bleed location in a compressor of the aircraft engine; and
when the aircraft engine is operating in the second engine operating condition, the flowing the second flow of cooling air comprises bleeding the second flow of cooling air from a second bleed location in the compressor downstream of the first bleed location.
